(19) United States
(12) Patent Application Publication
(10) Pub. No.: US 2002/0031996 A1
(43) Pub. Date: Mar. 14, 2002

(54) Machine for separating the flank from the loin of a carcass-half

(75) Inventors: Yvon Dufour, St-Anselme (CA); Jean-Guy Roy, St-Anselme (CA); Patrick Fauret, Outremont (CA)

Correspondence Address: ROBIC, 55 St-Jacques, Montreal, QC, H2Y 3X2, CA

(73) Assignee: G.-E. LEBLANC INC.

(21) Appl. No.: 09/985,224

(22) Filed: Nov. 2, 2001

Related U.S. Application Data
(63) Continuation-in-part of application No. 09/610,468, filed on Jul. 5, 2000.

(30) Foreign Application Priority Data
Jul. 9, 1999 (CA) 2 277 693

(51) Int. Cl. A22C 18/00

(52) U.S. Cl. 452/171

(57) ABSTRACT

A machine for processing a carcass-half comprising a loin and a flank partially separated by scribing. The machine has a frame which is fixed an elongated rectilinear working surface intended to receive and support the loin of the carcass-half to be processed. A conveying system is mounted onto the frame above the working surface for engaging and pressing the loin and moving it together with the flank connected thereto up to a cutting zone. A cutting blade is mounted to the frame in the cutting zone for engaging the loin when the frame is moved by the conveying system and for separating the flank from the loin. In this machine, the frame is devised to let the flank fall down from the working surface while the carcass-half is moved by the conveying system. As a result, more spacing is left between the cut ribs once the flank is folded down from the loin, thereby making the machine easier to operate.

### CROSS-REFERENCE

The present application is a continuation-in-part of U.S. patent application Ser. No. 09/610,468 filed on Jul. 5, 2000 with designation of the same inventors and same Applicant.

### FIELD OF THE INVENTION

The present invention relates to a machine for processing the central part of the carcass-half of an animal, especially a pork, in order to separate the flank from the loin of the central part.

### BACKGROUND OF THE INVENTION

As shown in FIG. 1 of the accompanying drawings, the central part of the carcass-half of a piece of meat comprises two main parts respectively called “loin” and “flank”. The loin is adjacent to the cut portion of the spinal column. The front portion of the loin contains ribs which are called “back ribs” after processing. In the rear portion of the loin is located the tender loin. The flank which is also called “belly”, is the part which is adjacent to the loin at the opposite of the spinal column. The ends of the ribs which extend along the flank can altogether be separated from the same to form “spare ribs”, or they can be removed individually. After removal of the ribs, the flank is mainly used to prepare bacon. The whole carcass-half is covered by an external layer of fat which extends under the loin and flank. The thickness of this layer of fat depends on several parameters including, inter alia, the size, the origin and the nutrition of the animal. This fat is the one that can be found in bacon. Therefore, it is important from a practical standpoint to keep a proper amount of fat together with the flank prior to cutting the same. Moreover, it is also important to remove some of the fat extending under the loin to avoid an over load of fat in the final product.

For trimming the fat off the loin, use is made of automatized machines called “loin pullers”, which are used in the cutting sections of the industrial slaughter houses.

Prior to processing a loin in a loin puller, it is of course necessary to separate it from the flank. So far, there have been two different methods of doing so.

The first method, called “Canadian cut”, consists in completely separating the flank from the loin by completely cutting the carcass-half according to a suitable cutting line which may vary depending on the need. An example of such a cutting line is shown in dotted lines in FIG. 1. Such a cutting can be carried out either manually or by means of another machine located upstream the loin puller or within the same. Once separated, the flank can be directed towards another machine or another working table specially adapted for this purpose, in order to separate the spare ribs. On the other hand, the loin is introduced into the loin puller, in order to trim off its fat.

A non-limitative example of loin puller specially adapted for processing loins after full separation from the adjacent flanks is disclosed in U.S. Pat. No. 5,090,939 issued on Feb. 25, 1992 in the name of the Applicant.

The second method, called “American cut”, consists in scribing (cutting) only the internal part of the carcass-half, that is the upper part of the carcass-half shown in FIG. 1, following the same type of cutting line as above, except for the fat. As a result, the layer of fat remains uncut and maintains altogether the loin and the flank. Then, both of them may be transferred together to a working table where the loin is processed to remove part of the layer of fat from the loin. The main advantage of this method is that it makes it possible to recover part of the fat and meat of the loin together with the flank, which part would otherwise have been left onto the loin and trimmed off by a cutting blade. Usually, this method of processing carcass-halves is carried out manually, even though industrial machines have been proposed to do it.

Thus, for example, U.S. Pat. No. 5,295,898 issued on Mar. 2^{nd}, 1994 in the name of ACRALOC CORP., discloses a loin puller especially adapted for processing carcass-halves having been subjected to an American cut. In this loin puller, each carcass-half is moved by two conveyors extending in parallel relationship towards a cutting zone where an arcuate blade which is preferably heated and whose height and curvature are adjustable, is positioned above the first conveyor supporting the loin for processing the same and trimming off its layer of fat. While the fat of the loin is cut, the flank is moved at the same speed along the second conveyor, which is positioned at the same level as the one of the first conveyor and may include another cutting zone where another knife cut the extra fat extending under the flank (see FIG. 3c of this patent).

In the loin puller disclosed in U.S. Pat. No. 5,295,898 as well as in all the other existing loin pullers used for processing carcass-halves having been subjected to an American cut, the loin and flank are maintained altogether in a same horizontal plane. Therefore, an operator provided with manual control means must very carefully follow the movement of the carcass-half to determine the optimum scribing line and to adjust accordingly the scribing saw while simultaneously adjusting the height of the cutting blade. Such requires much dexterity from the operator who must determine the scribing line and who has very few visual information to evaluate the thickness of the layer of fat and thus to adjust the height of the cutting blade. Indeed, the operator has no visual access to the layer of fat under the loin after the loin has been engaged by the cutting blade. The operator has also poor visual access to evaluate the position of the cutting blade relative to the ribs, because of the presence of the flank in horizontal position adjacent to the loin. As a result, the operating speed of the machine is reduced as compared to the loin pullers used for processing loins having been subjected to a Canadian cut.

The above mentioned U.S. patent application Ser. No. 09/610,468 to the Applicant discloses and claims a loin puller whose structure permits to solve the above mentioned problem. More particularly, U.S. application Ser. No. 09/610,468 discloses a loin puller which permits to process carcass-halves having been subjected to an American cut in view of trimming the fat off the loin while simultaneously permitting to the operator or to a detection system to determine the thickness of the back ribs on the loin and the thickness of the meat, and thus to evaluate the upper level of the layer of fat under the loin, such allowing an evaluation of the optimum height for positioning the arcuate blade for trimming off the fat with or without the adjacent lean meat depending on the user's requirement.

### SUMMARY OF THE INVENTION

It has now been discovered that the improved loin puller disclosed in U.S. application Ser. No. 09/610,468 to the same Applicant may also be used in a very efficient and advantageous way for processing a carcass-half comprising a loin and a flank partially separated by scribing in order to fully separate the loin from the flank.

More particularly, it has been discovered that if, after scribing, one lets the flank fold down and hang on one side of the loin while said loin is moved by the conveyor towards the cutting zone instead of supporting the flank by means of another conveyor, it is easier to determine the level of the layer of fat under the loin and/or the thickness of the ribs and/or the position of the lean meat along the same, such allowing optimum adjustment of the position of the cutting blade.

Thus, a first object of the invention is to provide a machine for processing a carcass-half comprising a loin and a flank partially separated by scribing, the machine comprising:

a frame;

an elongated rectilinear working surface fixed to the frame and intended to receive and support the loin of the carcass-half to be processed;

a conveying system mounted onto the frame above the working surface for engaging the loin, pressing said loin and moving said loin together with the flank connected thereto towards a cutting zone; and

a cutting blade mounted to the frame in the cutting zone for engaging the loin when the same is moved by the conveying system and for separating the flank from said loin.

In accordance with the invention, this method is improved in that the frame is devised to leave a lateral free-space adjacent one side of the working surface over the full length of the same up to the cutting blade, so as to let the flank fold down and hang from the working surface while the carcass-half is moved by the conveying system, whereby more spacing is left between the cut ribs once the flank is folded down from the loin, thereby making the machine easier to operate.

Preferably, guides in the form of plates and/or rigid tubes of metal can be provided at the inlet and along the machines to force the flank to fold down and hang relative to the loin. Such may be necessary when the carcass-half to be processed is very cold and rigidified by cooling or for other reasons.

Preferably also, the cutting blade extends from above the working surface to below the working surface and has a distorted portion close to the working surface so as to allow removal of fat from under the loin while the flank is separated from the loin.

A second object of the invention is to provide a method for processing a carcass-half comprising a loin and a flank partially separated by scribing, said method comprising the steps of:

positioning the carcass-half to be processed onto a working surface;

moving said carcass-half toward a cutting zone along said working surface by means of a conveying system; and

separating the flank from the loin by means of a cutting blade located in the cutting zone.

In accordance with the invention, this method is improved in that prior to cutting the flank from the loin, the flank is allowed to fold down and hang from the working surface whereby more spacing is left between the cut ribs once the flank is folded down from the loin, thereby making the cutting easier to carry out.

### BRIEF DESCRIPTION OF THE DRAWINGS

The invention will be better understood upon reading the following non-restrictive description of the preferred embodiment thereof, made with reference to the accompanying drawings in which:

FIG. 1 is a perspective view of a carcass-half showing the main parts of it, to which reference has been made hereinabove;

FIG. 2 is a side elevational view of a machine for processing a carcass-half according to a preferred embodiment of the invention;

FIG. 3 is a front view of the inlet of the machine shown in FIG. 2;

FIG. 4 is a side elevational view of the portion of the machine shown in FIG. 2, where is located the rigid guiding plate and the pivotable plate positioned downstream the rigid plate for giving a knock to the flank and folding it;

FIGS. 5a and 5b are perspective views showing in detail the operation of the pivotable plate used for giving a knock to the flank and folding it;

FIG. 6 is a rear view of the outlet of the machine shown in FIG. 2, said figure showing the cutting blade in use to cut the flank from the loin; and

FIG. 7 is a perspective view of the cutting blade of the machine shown in FIG. 2.

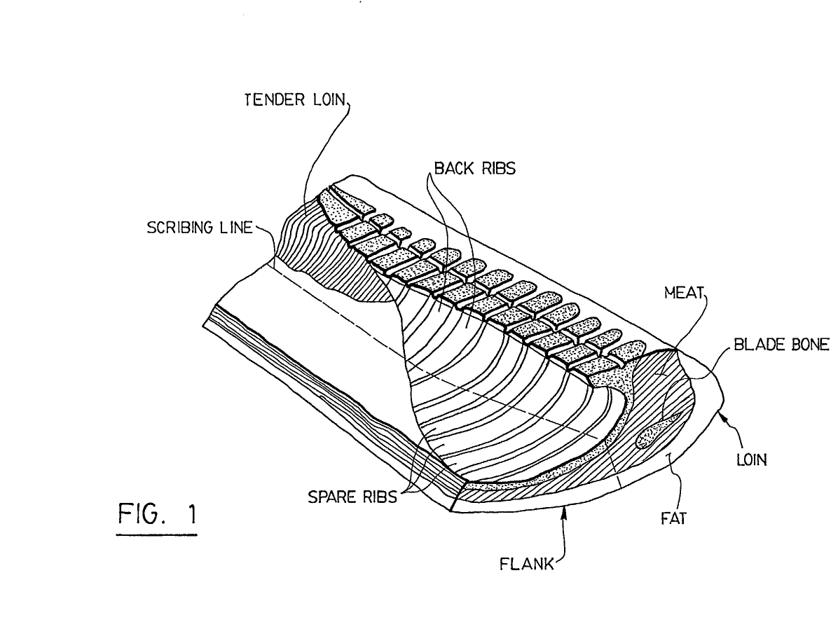

### DETAILED DESCRIPTION OF THE INVENTION

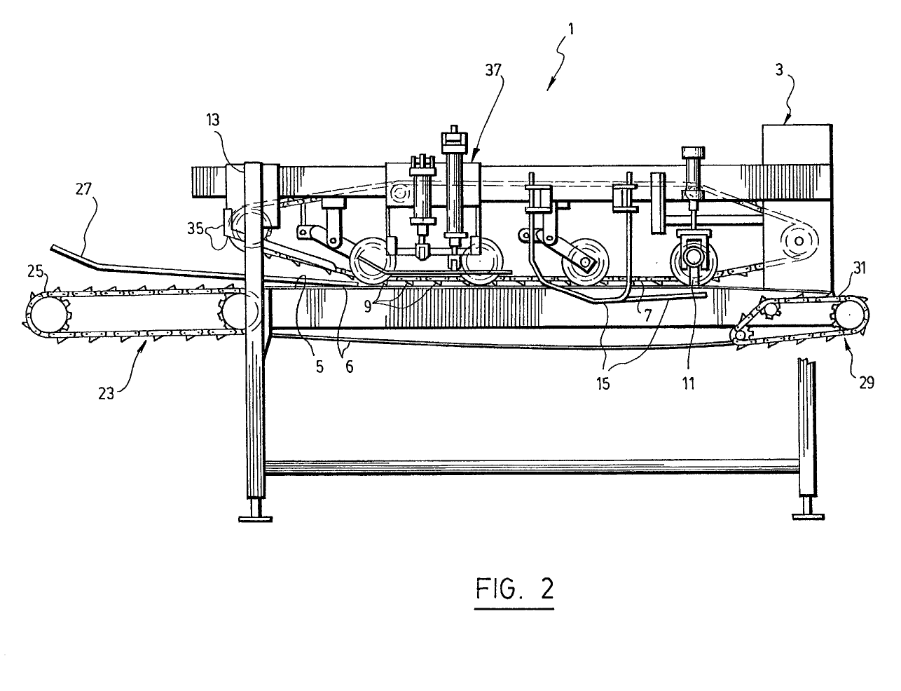

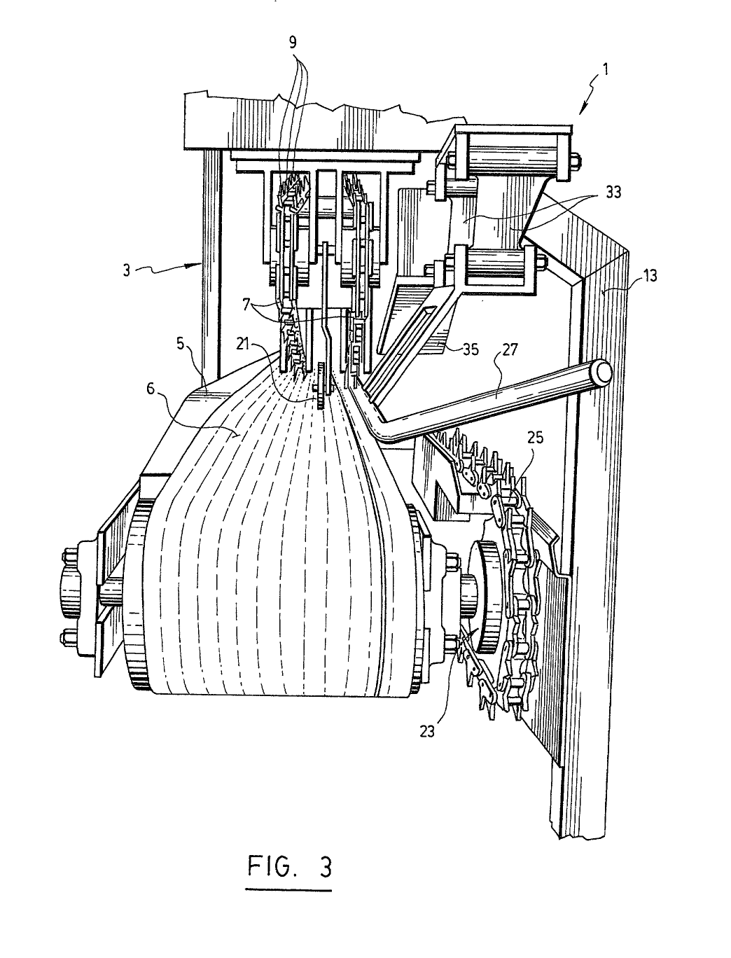

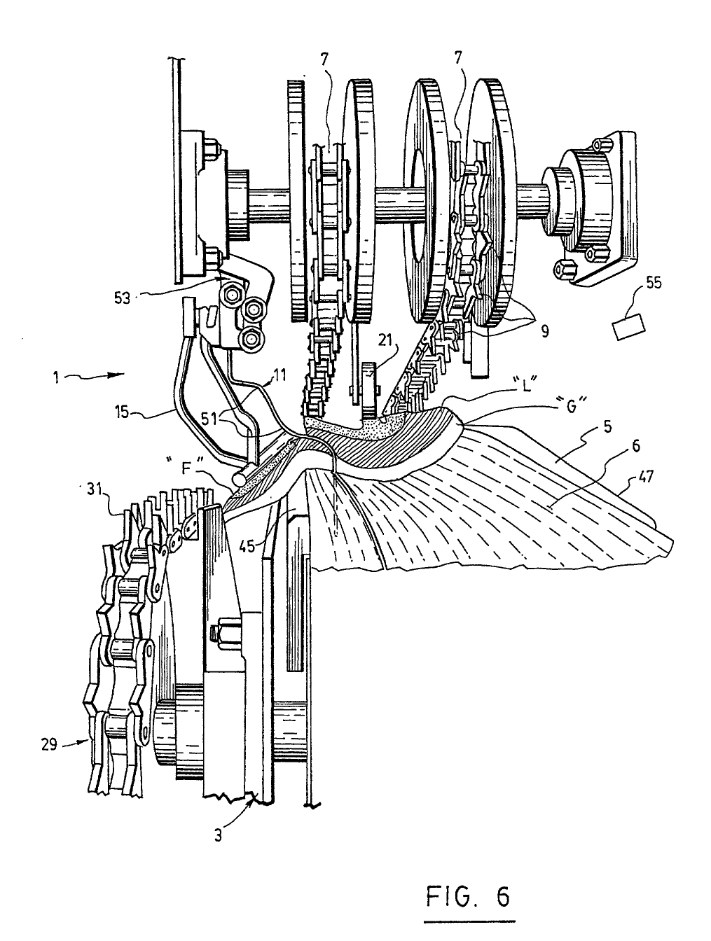

The machine according to the preferred embodiment of the invention as shown in FIGS. 2 to 6 comprises a frame 3 to which is fixed an elongated rectilinear working surface 5 preferably having a concave cross-section. An endless belt 6 is mounted onto the working surface 5 for facilitating the conveying of the carcass-halves along the working surface. As shown in FIGS. 3 and 6, several retractable rollers 21 held in lower position by means of return springs or cylinders are fixed to the frame above the belt for applying a pressure onto the same and thus maintaining the belt in contact with the working surface before and after passage of each carcass-half. The working surface 5 is intended to receive and support the loin “L” of a carcass-half to be processed, with the layer of fat “G” in downwards position.

A conveying system comprising two endless chains 7 each provided with teeth 9, is mounted onto the frame above the working surface for engaging the loin L, pressing on the same and moving it together with the flank F connected thereto toward a cutting zone located downstream, where a cutting blade 11 whose position is adjustable, is positioned to engage the carcass-half while the same is moving and to separate the flank F from the loin L.

This conveying system and its operation in synchronism with the belt 6 mounted onto the working surface 5 are well known in the art. In this connection, reference can be made to the content of the disclosure of U.S. Pat. No. 5,090,939 and to all the other patents that were cited during its examination.

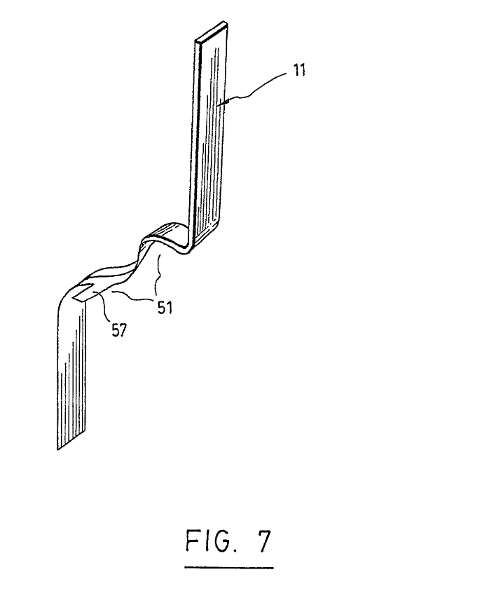

As is better shown in FIGS. 6 and 7, the cutting blade 11 extends from above the working surface to below the working surface and preferably has a distorted position 51 close to the working surface so as to allow removal of fat from under the loin while the flank is separated from the loin. The cutting blade 11 may also be provided with a tooth 57 projecting towards the conveying slightly below the distorted portion of the blade.

In use, the cutting can be controlled manually via means controlled by an operator for adjusting the position of the cutting blade as a function of the respective position of the flank and loin. Alternatively, the cutting can be controlled automatically by the combination of a detection system with means controlled by said detection system for adjusting the cutting blade. In the illustrated embodiment, means 53 operated either manually or by a detector 55 are provided for automatically adjusting the position the blade 11 when the blade passes close to the end of the carcass-half where is located the bone and/or the other end where is located the tenderloin.

As previously indicated, the present invention lies in that the machine puller 1 and more specifically its frame 3, are devised to leave a lateral free-space adjacent one side of the working surface over the full length of the same up to the cutting blade, so as to let the flank fold down and hang from the working surface 5 while the carcass-half is moved by the conveying system. For this purpose, the frame 3 is provided with supporting arches 13 leaving a lateral free space adjacent one side of the working surface 5 (see FIG. 3). The flank which hangs down with respect to the loin L as clearly shown in FIG. 6, provides better lateral visibility and thus permits to the operator or to the detection system to better adjust the position of the cutting blade 11 as a function of the respective position of the flank and loin.

For facilitating the operation of the machine, and more particularly the introduction and exit of the carcass-halves, an inlet conveyor 23 comprising an endless chain 25 provided with teeth, is positioned at the inlet of the loin puller 1 for supporting the flank when the carcass enters the loin puller. A guiding rod 27 is also positioned at the inlet of the loin puller for facilitating positioning of the loin on the working surface. An outlet conveyor 29 comprising an endless chain 31 provided with teeth, is positioned at the outlet of the loin puller for lifting up the flank and supporting the same when the carcass-half exits the loin puller. As is shown, the guiding rod 27 preferably consists of an horizontally extending rigid tube connected to the frame by means of a set of pivoting arms 33 forming a deformable parallelogram in order to be able to retract in a vertical plane depending on the thickness of the loin. Moreover, a guiding plate 35 is mounted in a rigid manner to the frame 3 above the inlet conveyor 23 upstream the same. As is shown, this guiding plate 35 extends at an angle in order to start folding the flank down from the carcass-half while said carcass-half is moved by the conveying system.

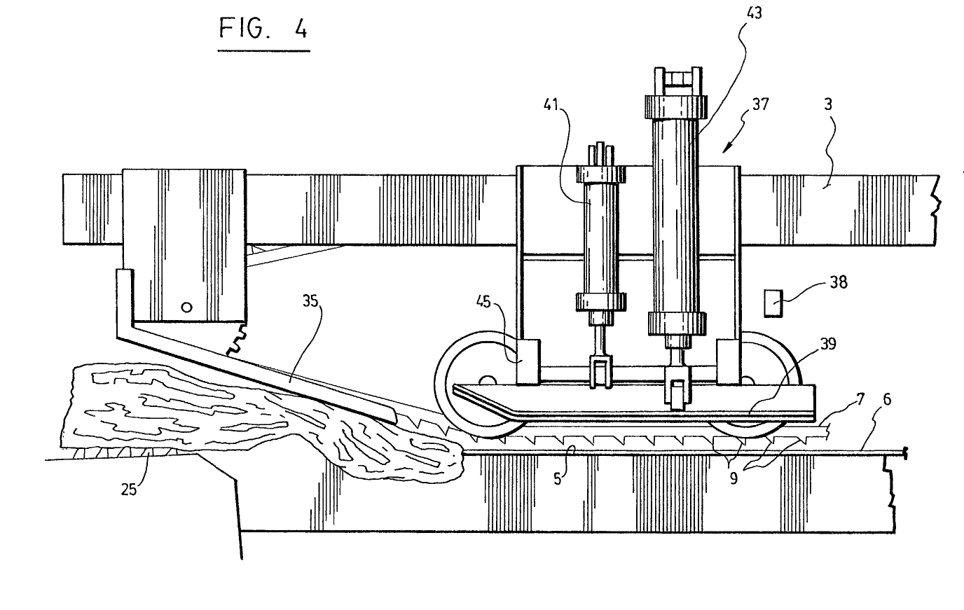

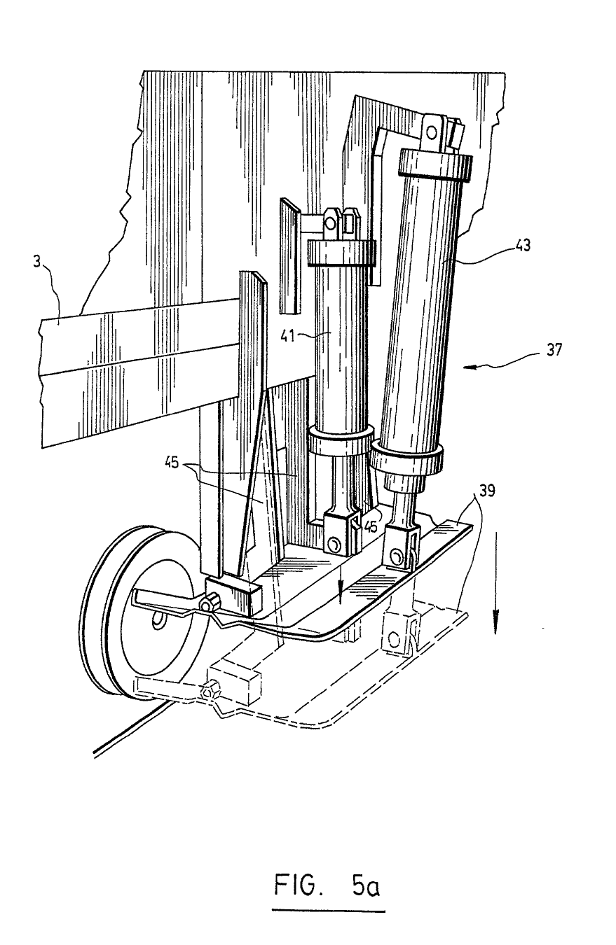

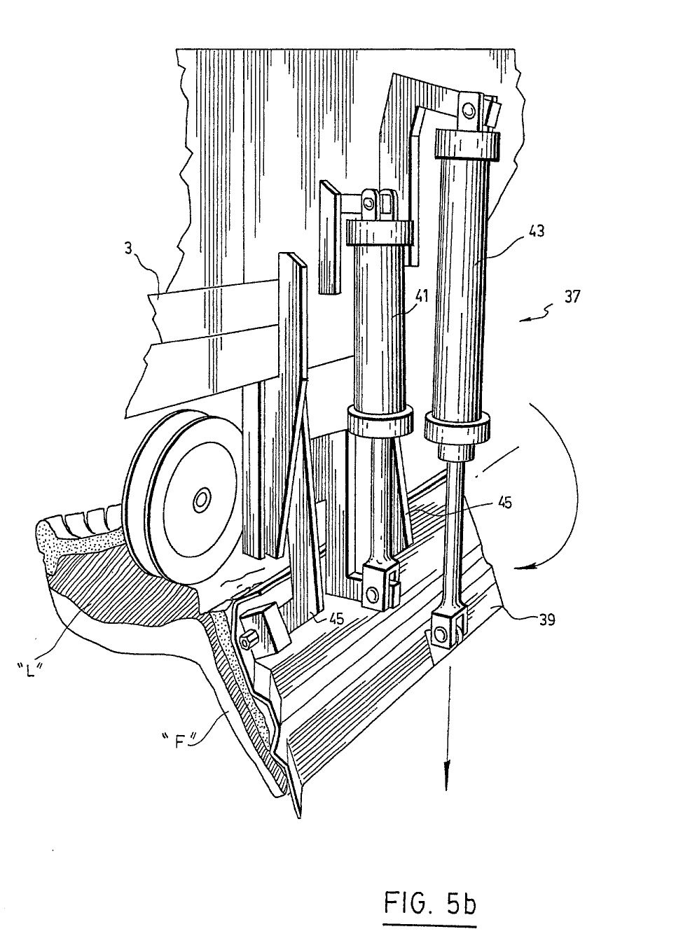

Because of the refrigeration of the carcass-halves to be processed or for any other reason, the flank may sometimes remain in the same plane as the loin to which it is attached. To force the flank to fold down and hang, mechanical means 37 may be mounted upstream the cutting knife. These means 37 are controlled by a detector 38 (see FIG. 4) for giving a knock onto the flank of the carcass-half while said carcass-half is moved by the conveying system. The knock which is so given, forces the flank to fold down and hang. The mechanical means 37 for giving a knock to the flank are shown in greater details in FIGS. 4, 5a and 5b. They preferably comprise a pivotable plate 39 mounted onto the frame 3 and at least one jack 41 and/or 43 mounted between the plate 39 and the frame 3 for moving the plate down and folding it from an horizontal position (see FIGS. 4 and 5a) down to an inclined position (see FIG. 5b) as soon as a signal is received from the detector 38 (see FIG. 4). In the illustrated embodiment, the plate 39 is mounted onto a piece 45 which is itself slidably mounted onto the frame 3 so as to be movable up and down. The first jack 41 lowers this piece 45 and the plate 39 pivotably connected thereto when a signal is received from the detector. The second jack 43 simultaneously forces the plate 39 to pivot.

Advantageously, a guide 15 consisting of a rigid tube is fixed to the frame downstream the pivoting plate. The guide 15 is fixed to the frame close to the cutting zone and is devised to engage the flank and hold it in folded position while the layer of fat is being cut.

As may be appreciated, the structure and operation of the machine 1 disclosed hereinabove make the cutting of the flank much easier to carry out. As a result, one may obtain product of very high quality at a much higher speed.

It is obvious that numerous modifications could be made to the preferred embodiment that has just been disclosed hereinabove without departing from the scope of the invention.

Thus, for example, the carcass-halves could be fed into the machine according to the invention with their shoulder side first or with their ham side first.

Also the machine according to the invention could not necessarily be operating in a continuous manner, with the conveying system moving the carcass-halves at a constant speed. As a matter of fact, the machine according to the invention could be operating sequentially.

Moreover, some structural component thereof could be operating in a different manner. Thus, by way of non-restrictive example, the cutting blade could be moved through the carcass-halves to be processed instead of having the carcass-halves being conveyed to the cutting blade as was disclosed hereinabove.

Last of all, the cutting knife 11 needs not necessarily be as shown in the drawings. By way of example, it could be devised like the one shown in U.S. Pat. No. 6,155,919 to Swift and Company, or it could be of any other shape provided that it allows separation of the flank from the loin.

1. In a machine for processing a carcass-half comprising a loin and a flank partially separated by scribing, said machine comprising:
a frame;
an elongated rectilinear working surface fixed to the frame and intended to receive and support the loin of the carcass-half to be processed;
a conveying system mounted onto the frame above the working surface for engaging the loin, pressing said loin and moving said loin together with the flank connected thereto towards a cutting zone; and
a cutting blade mounted to the frame in the cutting zone for engaging the loin when the same is moved by the conveying system and for separating the flank from said loin;
the improvement wherein:
the frame is devised to leave a lateral free-space adjacent one side of the working surface over the full length of the same up to the cutting blade so as to let the flank fold down and hang from the working surface while the carcass-half is moved by the conveying system, whereby more spacing is left between the cut ribs once the flank is folded down from the loin, thereby making the machine easier to operate.

2. The improved machine of claim 1, which further comprises means controlled by an operator for adjusting the cutting blade.

3. The improved machine of claim 1, which further comprises means controlled by a detection system for adjusting the cutting blade.

4. The improved machine of claim 1, which further comprises a guide fixed to the frame and devised in such a manner as to contact the top portion of the flank while the carcass-half is moved by the conveying system and to hold said flank in folded position.

5. The improved machine of claim 4, wherein the guide is made of a rigid tube.

6. The improved machine of claim 1, which further comprises mechanical means that are mounted upstream the cutting blade and are controlled by a detector for giving a knock onto the flank of the carcass-half while said carcass-half is moved by the conveying system, said knock forcing the flank to fold down and hang.

7. The improved machine of claim 6, wherein said mechanical means for giving a knock to the flank comprises a pivotable plate mounted onto the frame and at least one jack mounted between the plate and the frame for moving the plate down and folding it from an horizontal position down to an inclined position as soon as a signal is received from the detector.

8. The improved machine of claim 1, which has an inlet and an outlet and which further comprises:
an inlet conveyor comprising an endless chain provided with teeth, said inlet conveyor being positioned at the inlet of the loin puller for supporting the flank when the carcass-half enters the loin puller;
a guiding rod also positioned at the inlet of the loin puller for facilitating positioning of the carcass-half onto the working surface; and
an outlet conveyor also comprising an endless chain provided with teeth, said outlet conveyor being positioned at the outlet of the loin puller for lifting up the flank and supporting the same when said carcass-half exits the loin puller.

9. The improved machine of claim 8, wherein the guiding rod consists of an horizontally extending rigid tube connected by means of pivoting arms to the frame in order to be able to retract in a vertical plane.

10. The improved machine of claim 8, further comprising a guiding plate mounted in a rigid manner to the frame above the inlet conveyor just downstream the same, said guiding plate extending at an angle in order to start folding the flank of the carcass-half while said carcass-half is moved by the conveying system.

11. The improved machine of claim 1, wherein:
the working surface has a concave cross-section;
an endless belt is mounted onto said working surface; and
retractable rollers are fixed onto the frame above the belt for applying a pressure thereto and thus for maintaining said belt in contact with the working surface before and after passage of the carcass-half.

12. The improved machine of claim 11, wherein the working surface of concave cross-section has two lateral sides and the lateral side of said the working surface on which extends the flank, is of a lower height than the other.

13. The improved machine according to claim 1, wherein:
the cutting blade extends from above the working surface to below said working surface and has a distorted portion close to said working surface so as to allow removal of fat from under the loin while the flank is separated from the loin.

14. The improved machine of claim 13, wherein:
the cutting blade is provided with a tooth projecting towards the conveying belt slightly below the distorted portion of the blade.

15. The improved loin puller of claim 4, which further comprises:
mechanical means that are mounted upstream the cutting blade and are controlled by a detector for giving a knock onto the flank of the carcass-half while said carcass-half is moved by the conveying system, said knock forcing the flank to fold down and hang;
an inlet conveyor comprising an endless chain provided with teeth, said inlet conveyor being positioned at the inlet of the loin puller for supporting the flank when the carcass-half enters the loin puller;
a guiding rod also positioned at the inlet of the loin puller for facilitating positioning of the carcass-half onto the working surface; and
an outlet conveyor also comprising an endless chain provided with teeth, said outlet conveyor being positioned at the outlet of the loin puller for lifting up the flank and supporting the same when said carcass-half exits the loin puller; and
a guiding plate mounted in a rigid manner to the frame above the inlet conveyor just downstream the same, said guiding plate extending at an angle in order to start folding the flank of the carcass-half while said carcass-half is moved by the conveying system.

16. The improved machine according to claim 15, wherein:
the cutting blade extends from above the working surface to below said working surface and has a distorted portion close to said working surface so as to allow removal of fat from under the loin while the flank is separated from the loin.

17. In a method for processing a carcass-half comprising a loin and a flank partially separated by scribing, said method comprising the steps of:
positioning the carcass-half to be processed onto a working surface;
moving said carcass-half toward a cutting zone along said working surface by means of a conveying system; and
separating the flank from the loin by means of a cutting blade located in the cutting zone;
the improvement wherein:
prior to separating the flank from the loin, the flank is allowed to fold down and hang from the working surface whereby more spacing is left between the cut ribs once the flank is folded down from the loin, thereby making the cutting easier to carry out.

18. The improved method of claim 17, wherein the flank is allowed to fold down by engagement under a guide made of a rigid tube.

19. The improved method of claim 17, wherein the flank is allowed to fold down by application of a knock onto the flank by means of a foldable plate.

20. The improved machine according to claim 17, wherein:
the cutting blade extends from above the working surface to below said working surface and has a distorted portion close to said working surface so as to allow removal of fat from under the loin while said flank is separated from the loin.
